(19) United States
(12) Patent Application Publication
(10) Pub. No.: US 2010/0299190 A1
(43) Pub. Date: Nov. 25, 2010

(54) AUTOMOTIVE MARKET PLACE SYSTEM

(76) Inventors: Tim Pratt, San Francisco, CA (US); Len Short, San Francisco, CA (US); Rob Vucic, San Francisco, CA (US); Iain Mulholland, San Francisco, CA (US); Timothy G. Dowling, San Francisco, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/784,401

(22) Filed: May 20, 2010

Related U.S. Application Data
(60) Provisional application No. 61/213,245, filed on May 20, 2009.

(51) Int. Cl. G06Q 30/00; G06Q 99/00

(52) U.S. Cl. 705/14.4; 705/347

(57) ABSTRACT

A method for ranking vehicles for sale, the method comprising (1) providing a first database of available vehicles, (2) creating a second database of similar vehicles by identifying vehicles in the first database that are similar to a subject vehicle, and (3) creating a third database of ranked vehicles by determining a vehicle rank score of each of the vehicles in the second database, wherein determining a vehicle rank score of a vehicle comprises (a) calculating a base score of the vehicle, (b) calculating a multiplier of the vehicle, and (c) determining the vehicle rank score of the vehicle by multiplying the base rank by the multiplier.

### RELATED PATENTS

This application claims priority to U.S. Provisional Patent Application No. 61/213,245 filed May 20, 2009, the content of which is incorporated by reference herein in its entirety.

### FIELD OF THE INVENTION

This disclosure generally relates to online automobile transactions and, more particularly, to a method and system of providing purchase recommendations to assist consumers in Internet automobile transactions.

### BACKGROUND OF THE INVENTION

An automobile purchase is a daunting prospect for the uninitiated, both for the myriad choices and risk of exploitation. Numerous car-manufacturers offer numerous car models with numerous customizable options. The large volume of permutations makes meaningful comparisons difficult and time-consuming for the average consumer.

All of the foregoing concerns are heightened in a used-car transaction because the considerations that factor into a used vehicle valuation are more numerous and uncertain. In addition to the new vehicle purchase considerations of options, model, and warranty, a used vehicle valuation must incorporate the used vehicle's history. For example, a used vehicle's accident history can reveal much about its long-term durability, reliability, and its desirability. Other considerations, such as the number of miles driven, the number of previous owners, or the remaining warranty coverage may be important factors in the valuation process. As the number of relevant considerations increases, it becomes more complex to determine a fair market value for a vehicle.

In light of the above, it is clear why the uninitiated vehicle purchaser can feel overwhelmed by the vehicle purchase process and struggle to reach a comfortable vehicle purchasing decision. Systems have been developed which attempt to resolve this problem. For example, Kelly Blue Book® asks a purchaser to enter the make, model, year, mileage, location, optional features, and the condition of a hypothetical subject vehicle. A suggested value is then provided for the hypothetical vehicle based on the parameters entered. The benefit to the purchaser manifests when the suggested price is compared to available vehicles' prices. The process, however, requires the user to compare the features of all the available vehicles against the hypothetical vehicle she has created. Problems arise, and the system fails, when an available vehicle differs from the hypothetical vehicle. In that scenario, the user must mentally guess or estimate a price adjustment to account for differences between the hypothetical and available vehicles or repeat the process above by reentering all the parameters of a second hypothetical vehicle. This process can repeat indefinitely for varying vehicle parameters providing little useful information to the purchaser or, worse, providing misinformation that can lead a purchaser to undervalue or overvalue an available vehicle.

Even when armed with a valuation of a hypothetical vehicle, the purchaser must still search inventory listings. The Internet marginally eases the purchaser's task. With the vast majority of dealers posting their inventory and offering prices online, a purchaser can anonymously search for a suitable vehicle and compare it to other available vehicles. Furthermore, this search can be done without entering a dealership, thereby avoiding conversing with a salesman who may waste the purchaser's time or, at worst, prove untrustworthy. However, the benefits of these prior art automobile research websites are limited because they do not ascertain a fair or best price for a particular vehicle they are interested in. For the purchaser who has not specifically narrowed down her search, perusing available vehicles can be time-consuming. Moreover, the purchaser can never be certain a comprehensive search of available vehicles has been achieved.

To overcome the above search issues, the Internet search could be automated by using traditional search techniques, called “web-crawlers,” which are designed to automatically search the Internet for relevant vehicle sales information. However, it is prohibitively expensive to crawl the entire Internet just to acquire a comprehensive list of domains that contain vehicle inventory. Even if such a list were obtained, it would still be prohibitively expensive to completely crawl each listing site because the actual vehicle listings may comprise only a small fraction of the overall content on the site. In addition, the format and hierarchy of vehicle-listing sites do not conform to a particular standard and the discovery and information architecture differences present significant challenges to web crawlers that are explicitly looking for vehicle inventories.

Traditional vehicle search engines rely on the use of parametric search techniques to allow a user to refine an initial search, but this too presents significant problems. Although such techniques are generally understood by website users, purchasers suffer the disadvantage of over-constrained searches returning few, if any, results. This inefficiency is partly attributable to the rigid search parameters, which precludes atypical parameters, such as, for example, a heated seat, an iPod adaptor, or a sports package.

Finally, to protect vehicle purchasers, standardized information displays, called “Monroney Stickers,” are federally mandated to be included on all new vehicles offered for sale and are intended to ease price and feature-based comparisons. No such display is required for a used vehicle. Used-vehicle facsimiles of the Monroney sticker do exist, but non-uniformity prevents reliable comparison. Further, attempts at used vehicle Monroney stickers only seek to replicate the data typically found on new vehicle Monroney stickers, which omits many of the key considerations relevant to the used vehicle's valuation. These deficiencies present significant challenges for used vehicle purchasers since data relating to vehicles is therefore presented in a huge variety of different styles and formats that require the vehicle purchaser to mentally normalize the data themselves in order to make comparisons across the available inventory, if relevant data is provided at all.

In light of the problems in the prior art, what is needed is an automotive market place system that enables a purchaser to make an efficient and informed purchase decision, that provides a comprehensive vehicle inventory search and retrieval system, that provides a vehicle search engine which allows for searches of non-conforming parameters, and a consistent and meaningful display of used vehicle valuation parameters.

### SUMMARY OF THE INVENTION

In accordance with one exemplary embodiment of the present invention, a method for ranking vehicles for sale is disclosed, the method comprising providing a first database of available vehicles, creating a second database of similar vehicles by identifying vehicles in the first database that are similar to a subject vehicle, and then creating a third database of ranked vehicles by determining a vehicle rank score of each of the vehicles. Determining a vehicle rank score of a vehicle comprises calculating a base score and a multiplier for the vehicle, and then multiplying the base rank score by the multiplier.

In accordance with another exemplary embodiment of the present invention, a method for providing a purchase recommendation for a subject vehicle to a purchaser is disclosed, the method comprising providing a first database of available vehicles, creating a second database of similar vehicles by identifying vehicles in the first database that are similar to the subject vehicle, assigning each of a plurality of vehicles in the second database to one of a plurality of comparable vehicle bands, assigning an average offer price to each of the plurality of comparable vehicle bands, assigning the subject vehicle to one of the plurality of comparable vehicle bands, and providing the purchase recommendation for the subject vehicle by comparing the offer price of the subject vehicle with the average offer price of the subject vehicle's comparable band.

### BRIEF DESCRIPTION OF THE DRAWINGS

FIG. 1 illustrates a vehicle purchase recommendation system in accordance with an exemplary embodiment of the present invention.

FIG. 2 illustrates a base rank scoring algorithm for use in the vehicle purchase recommendation system of FIG. 1.

FIG. 3 illustrates another base rank scoring algorithm for use in the vehicle purchase recommendation system of FIG. 1

FIG. 4 illustrates an exemplary base rank score calculation resulting from the vehicle purchase recommendation system of FIG. 1.

FIG. 5 illustrates a vehicle purchase recommendation system in accordance with an exemplary embodiment of the present invention.

FIG. 6 illustrates an exemplary results list of a vehicle Internet listings discovery crawl in accordance with an exemplary embodiment of the present invention.

FIG. 7 illustrates URLs seed resulting from the discovery crawl of FIG. 6.

FIG. 7A illustrates exemplary URL path patterns resulting from the URL seeds of FIG. 7.

FIG. 8 illustrates an exemplary universal digital vehicle sticker.

FIG. 8A illustrates an exemplary bid system & message system 806

FIG. 9 illustrates exemplary parametric vehicle-listing search filters.

FIG. 10 illustrates a keyword enabled vehicle search in accordance with an exemplary embodiment of the present invention.

FIG. 11 illustrates an automotive market place system 1100 in accordance with an exemplary embodiment of the present invention.

### DETAILED DESCRIPTION OF EXEMPLARY EMBODIMENTS

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the invention.

In an automotive market place system in accordance with an exemplary embodiment of the present invention, a purchase recommendation is provided to customers for specific vehicles available for purchase. In this way, the present invention reduces the risk of consumer error in the valuation process and enables the user to review purchasing options vehicle-by-vehicle. The system facilitates purchaser decision-making by correlating the preferred vehicle parameters to a dynamic database of available vehicles.

In an automotive market place system in accordance with another exemplary embodiment of the present invention, an Internet search process is provided which progressively focuses the search on targets with more potential, allowing for a substantial reduction in the cost of finding and “crawling” vehicle inventory listings on the Internet.

In an automotive market place system in accordance with yet another exemplary embodiment of the present invention, a vehicle search engine is provided which relies upon keyword processing to infer the intent of a user's search and return results based on their relevancy to the search. In this way, the present invention allows for a broader range of search terms to be used and for more reliable search results.

In an automotive market place system in accordance with yet another exemplary embodiment of the present invention, a Universal Digital Vehicle Sticker is provided which visually normalizes the key data for both new and used vehicles across all listings and represents this data in a uniform manner regardless of the source of the underlying listing data. In this way, the present invention allows for rapid, detailed, side-by-side comparisons of vehicle inventory by purchasers regardless of the underlying format of the original inventory listing. Furthermore, the Universal Digital Car Sticker is portable in that, once generated, it can be displayed on any website or printed. In this way, the Universal Digital Vehicle Sticker of the present invention can be widely adopted and used.

Purchase Recommendation System

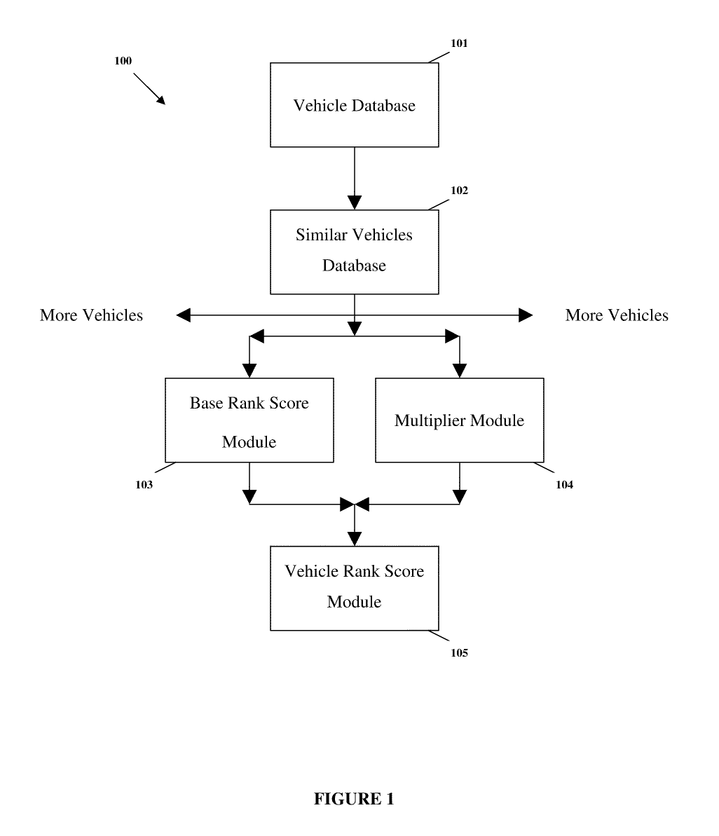

FIG. 1 illustrates a block diagram of a vehicle purchase recommendation system 100 in accordance with an exemplary embodiment of the present invention. Vehicle purchase recommendation system 100 includes a vehicle database 101, a similar vehicles database 102, a base rank score module 103, a multiplier module 104, and a vehicle rank score module 105.

In this embodiment, vehicle purchase recommendation system 100 calculates a vehicle rank score for each vehicle in the similar vehicles database 102. Similar vehicles database 102 may be created, for example, by identifying all vehicles within the vehicle database 101 that share the same manufacturer, model, and year. However, it is understood that any vehicle parameters may be selected as the basis for creating the similar vehicles database 102.

For each vehicle in the similar vehicles database 102, a base rank score is calculated by the base rank score module 103 and a multiplier value, or weighting value, is calculated by multiplier module 104. Exemplary base rank score algorithms and multiplier algorithms are described in more detail below. For each vehicle in the similar vehicles database, a vehicle rank score is determined by multiplying its base rank score by its multiplier value. FIG. 1 illustrates the purchase recommendation process for one vehicle, but it is understood that the base rank score module 103 and multiplier module 104 are applied to many vehicles in the similar vehicles database 102 to determine each vehicle's vehicle rank score. Once the vehicle rank score is calculated, it may be provided to the user for comparison with other similar vehicles or may be used in another algorithm, for example.

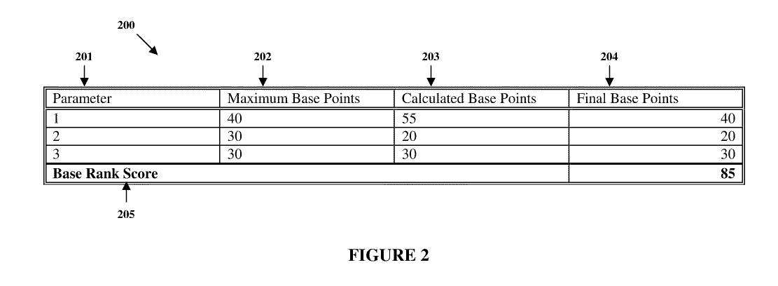

An exemplary base rank scoring module 200 used by the base rank score module 103 is illustrated in FIG. 2. Base rank scoring module 200 calculates s subject vehicle's base rank score 205 based on one or more predetermined parameters 201, by calculating the base points 203 for each parameter, and then determining the final base points 204 for each parameter. The subject vehicle's base rank score 205 is the sum of the final base points 204 for all parameters. Base rank scoring module 200 is provided by way of example and any number of alternative formulations could be used.

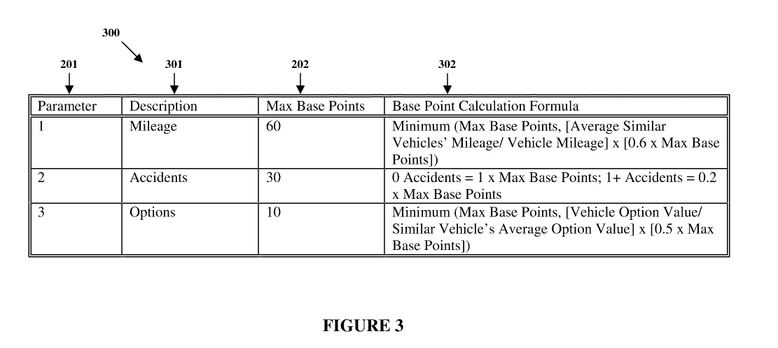

The calculated base points 203 for each parameter is determined by a base point calculation formula (not shown). An exemplary base point calculation formula is described in more detail below with respect to FIG. 3. In the embodiment of FIG. 2, the final base points 204 for each parameter is limited by a maximum base points value 202. In the event that the calculated base points 203 exceeds the maximum base points 202 for each parameter 201, the final base points 204 for that parameter is limited to the maximum base points 202, as can be seen with respect to parameter 1 in FIG. 2. The subject vehicle's base rank score 205 is determined by adding the final base points 204 for each parameter 201.

FIG. 2 illustrates an exemplary base rank scoring module 200 using 3 parameters, but it will be readily understood by one of ordinary skill in the art that any number of vehicle parameters could be used, including more or less than 3. Further, the sum of maximum base points 202 equals 100, but any maximum base points could be used for each parameter which may, or may not, sum to 100. In addition, maximum base points are an optional feature of the present invention and it should be understood that the final base points could be determined without a maximum base points restriction.

FIG. 3 illustrates an exemplary base point calculation module 300, which can be utilized in the base rank scoring module 200 described above with respect to FIG. 2. Base point calculation module 300 contains parameters 201, a description 301 for each parameter, maximum base points 202 for each parameter, and base point calculation formula 302 for each parameter.

For each parameter in FIG. 3, a base point calculation formula is provided. For example, for parameter 1, mileage, the base point calculation formula 302 comprises taking the minimum of (1) the maximum base points 202 and (2) the average mileage for similar vehicles divided by the subject vehicle's mileage and multiplying the result by 60% of the max base points. The base point calculation formula thereby accords a weight to a parameter of a specific vehicle enabling meaningful comparison of the value of different vehicles. The maximum base points value 202 ensures the base rank scoring algorithm does not accord undue weight to a particular parameter.

In FIG. 3, exemplary parameter descriptions 301 are given, but any vehicle parameters may be used. Further, for the parameters provided in FIG. 3, exemplary base point calculation formulas are provided, but the formulas may take this or any other form, which may be predetermined or user modified. In addition, the max base points 202 may be predetermined or user modified.

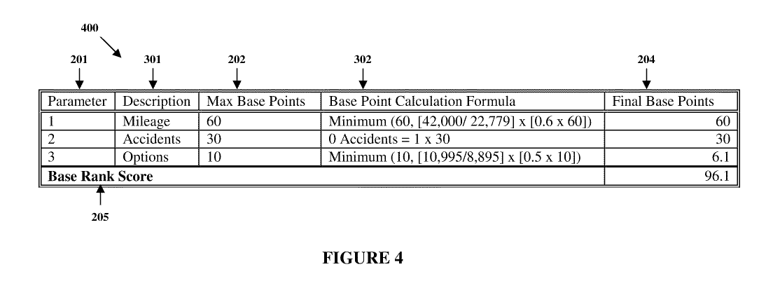

FIG. 4 illustrates an exemplary base rank score algorithm 400 for a sample vehicle based on base point calculation module 300 described above with respect to FIG. 3. Base rank score algorithm 400 contains parameters 201, a description 301 for each parameter, maximum base points 202 for each parameter, base point calculation formula 302 for each parameter, final base points 204 for each parameter, and a base rank score 205.

Consider the following hypothetical scenario. The similar vehicles database used for the base rank score algorithm 400 has an average asking price of $69,695, an average options values of $8,895, and an average mileage of 42,000. The sample vehicle has an asking price of $72,975, manufacturer's suggested retail price (“MSRP”) options value of $10,995, mileage of 22,779, and no accidents. Applying these parameters to the base point calculation module 300 gives a base rank score of 96.1 for the sample vehicle, as shown in FIG. 4. It is to be understood that the parameters given here are offered for illustration purposes only, and should not be considered to limit the present invention in any way.

Referring now to FIG. 1, in one embodiment, a subject vehicle's multiplier value generated by multiplier module 104 is calculated based on the base rank score of all the vehicles in the similar vehicles database. In one embodiment, the similar vehicles database can be divided into four quarters: (1) a first quarter percentile, which includes all similar vehicles whose base rank score is in the 75-100% percentile, (2) a second quarter percentile, which includes all similar vehicles whose base rank score is in the 50-75% percentile, (3) a third quarter percentile, which includes all similar vehicles whose base rank score is in the 25-50% percentile, and (4) a fourth quarter percentile, which includes all similar vehicles whose base rank score is in the 0-25% percentile. The subject vehicle is then assigned to one of the quarter percentiles, based on the subject vehicle's base rank score. To calculate the multiplier value, the average asking price of all vehicles in the subject vehicle's quarter percentile is divided by the asking price of the subject vehicle. It should be understood that the multiplier algorithm described here is given by way of example and any algorithm could be used without departing from the spirit of the invention.

To illustrate a vehicle rank score calculation, consider again the sample vehicle discussed above with respect to FIG. 4. Assume the average asking price of the sample vehicle's quarter percentile is $78,000. Because the asking price of the sample vehicle is $72,975, the subject vehicle's multiplier value is $78,000/$72,975=1.07. Because the subject vehicle's base rank score is 96.1 and the subject vehicle's multiplier value is 1.06, the subject vehicle's vehicle rank score is 96.1×1.07=102.83. In accordance with an exemplary embodiment of the present invention, this process is repeated and a hierarchy of vehicles is created for the purchase price recommendation.

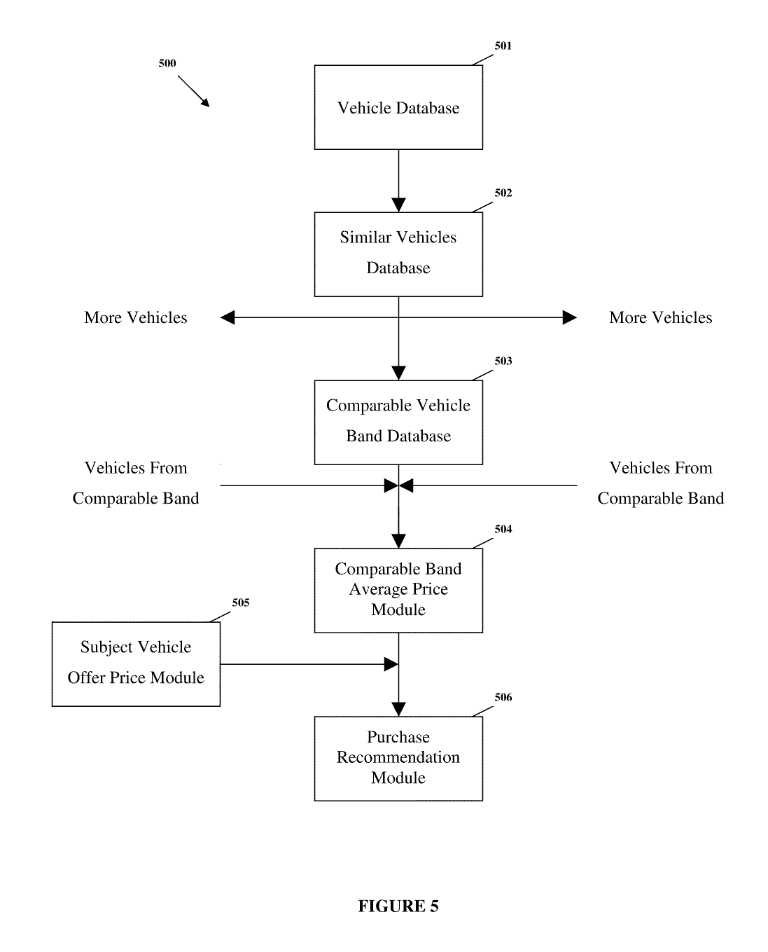

FIG. 5 illustrates a block diagram of an exemplary vehicle purchase recommendation system 500 in accordance with an embodiment of the present invention. Vehicle purchase recommendation system 500 includes a vehicle database 501, a similar vehicles database 502, a comparable vehicle band database 503, a comparable band average price module 504, subject vehicle offer price module 505, and purchase recommendation module 506.

Each vehicle in the vehicle database 501 is assigned to a similar vehicles database 502. Similar vehicles database 502 may be created, for example, by identifying all vehicles within vehicle database 501 that share the same manufacturer, model, and year. However, it is understood that any vehicle parameters may be selected as the basis for creating the similar vehicles database 502.

Each vehicle in similar vehicles database 502 is assigned to a comparable vehicle band database 503. A comparable band assignment may include, for example, assigning the vehicle to one of three bands corresponding to excellent cars, great cars, and acceptable cars. The excellent car band may include, for example, all vehicles in the similar vehicle database that (1) are located within a predetermined, or user chosen, distance from the purchaser's location, (2) have no accidents, and (3) have less than 15,000 miles driven per year. The great car band may include, for example, all vehicles in the similar vehicle database that (1) are located within a predetermined, or user chosen, distance from the purchaser's location, (2) have no accidents, and (3) have between 15,000 and 25,000 miles driven per year. The acceptable car band may include, for example, all vehicles in the similar vehicle database that (1) are located within a predetermined, or user chosen, distance from the purchaser's location and (2) have had 1 accident or have had no accidents but greater than 25,000 miles driven per year. This comparable band assignment is offered for illustrative purposes only and any comparison of vehicle parameters may be used without deviating from the spirit of the invention. Further, three comparable bands are described here by way of example, but any number of comparable bands may be used without deviating from the spirit of the invention.

Once the comparable vehicle band database 503 is created, the average price of the vehicles in each comparable band is determined by the average price module 504. The average price is compared to the subject vehicle's offer price, provided by subject vehicle offer price module 505, to determine a purchase recommendation by the purchase price recommendation module 506. The purchase price recommendation may include, for example, a “good price” recommendation or a “great price” recommendation. A good price may be recommended if the subject vehicle's offer price 505 is within 95-100% of the subject vehicle's comparable band offer price created by the average price module 504. A great price may be recommended if the subject vehicle's offer price is less than or equal to 95% of the subject vehicle's comparable band offer price. This purchase price recommendation is offered for illustrative purposes only and any system that compares the subject vehicle's offer price to the comparable band average price could be used without deviating from the spirit of the invention.

Vehicle Database

A vehicle database in accordance with an embodiment of the present invention will now be described. The vehicle database may represent vehicle database 101 described above with respect to FIGS. 1-4 or vehicle database 501 described above with respect to FIG. 5, but is not limited to those embodiments. Data included in the vehicle database, such as available vehicles and relevant vehicle parameters, may be obtained through, for example, updating of inventory information by licensed dealers and/or through any Internet vehicle-inventory search system designed to locate data for on-sale vehicles listed on the Internet. The vehicle database is continuously updating, thereby maintaining current data on the vehicles in the database.

An Internet vehicle-inventory search system for gathering on-sale vehicular data from the Internet in accordance with the present invention will now be described. In accordance with an exemplary embodiment of the present invention, the vehicle inventory search has three stages: (1) the seeding stage, (2) the discovery crawl stage, and (3) the listings crawl stage. As used herein, “seeding” could be understood to refer to any method for discovering Internet domains that may contain vehicle listings. The result of the seeding stage is a list of Internet domains that are targets for the discovery crawl stage. The result of the discovery crawl stage is a list of uniform resource locator (“URL”) paths that are believed to host vehicle inventory listings and a list of seed URLs that are known to contain vehicle inventory listings. These seed URLs are used first in the listing crawl stage. Each of the stages will now be described in more detail.

Stage 1: Seeding

There can be any number of inputs to the seeding process, including results a search engine API (described in more detail below), commercially available listings of dealers, manually generated lists from, for example, business cards, automated data feeds from third party data providers. The seeding inputs can be supplemented with a list of targets from an external source such as a purchased list of vehicle dealer contacts, for example. However, such lists are often incomplete and require supplementation.

One method of seeding is to enter search terms, either predetermined or linked to a specific user search, into a search engine application program interface (“API”), such as the Yahoo Boss Search API. The method can be modified to use the base domains of any number of the results, such as, for example, the first 3 results which appear on the Yahoo Boss Search API. The number of base domain names can determine the breadth of the discovery crawl, described in more detail below.

Search terms can be auto-generated using standard keywords defining vehicle make, model, geographic area and other modifiers such as configuration parameters (including, but not limited to, year, exterior color, interior color, standard equipment, optional equipment, original MSRP pricing for the base vehicle and optional equipment, warranty, safety ratings, and mileage ratings) and history parameters (including, but not limited to, number of miles, number of accidents, remaining tire tread, remaining warranty, maintenance history and condition, where condition (e.g., like new, excellent, good, or poor)).

An exemplary search term is “Audi authorized dealer San Francisco,” which may return “Bay Area Motor Sales Audi” as the first result and include the domain www.sfmotorsales.com in the result. In addition, purchased dealer contact lists can be augmented in the same manner to identify a dealer's Internet site where only the dealership name is known. For example, the first result for “Tom Dealer Audi” may include the domain www.tdealeraudi.com.

Stage 2: Discovery Crawl

The discovery crawl stage uses the results of the seeding stage above, i.e., the list of target domain names. The discovery crawl is designed to reduce the amount of content on a specific domain that has to be searched in order to find actual vehicle inventory listings from which the relevant vehicle data can be extracted.

In one embodiment, the discovery crawl exploits three commonalities associated with vehicle listings sites. First, each site generally uses consistent style and layout formats for all vehicles listed within that site. Secondly, common site information design dictates that similar content should be contained in the same URL path. Finally, the design of a particular site rarely changes over time.

The discovery crawl uses the same process as the listings crawl, but is configured differently. The discovery crawl starts with the root domain and expands outwards from that domain to a maximum number of pages. In an exemplary embodiment, the discovery crawl expands from a root domain to several hundred pages. Offsite links, however, are only expanded to a depth of one.

Once the discovery crawl has completed a particular domain, a parsing process is run. The parsing process is designed to find pages which are believed to contain vehicle listings, using the same parser as the crawl stage. This parser looks for key identifiers such as, for example, the presence of VIN numbers on a web-page. The parser then tags those pages within the sample set that are believed to contain vehicle inventory listings. A second process is then run against URLs from the pages in the sample set to remove URL parameters and reduce the URLs to common paths. The output of these two processes results in a list of cleaned URL paths that may contain inventory. A distribution histogram of the URLs is then constructed and the largest distribution is selected as a candidate URL.

Because the design of a particular site rarely changes over time, the discovery crawl need only run periodically, since the rate of change of URLs that it discovers may be relatively small.

In this manner, a list of target URLs can be generated that constrains the listings crawl to the inventory listings on a website and not the entire site, thereby saving substantial resources.

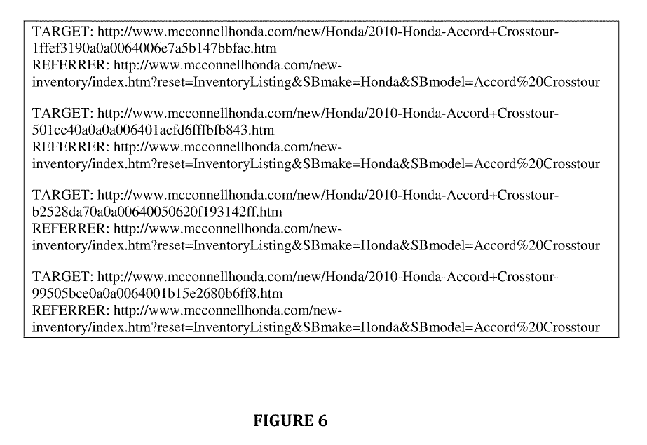

An exemplary results listing of a discovery crawl is provided in FIG. 6. The results of the crawl were parsed and URLs containing inventory were marked as “Target.” The Referrer URL for these Target URLs was then extracted. Note that FIG. 6 contains a representative data sample and a full extract might contain many hundreds of Target URL's.

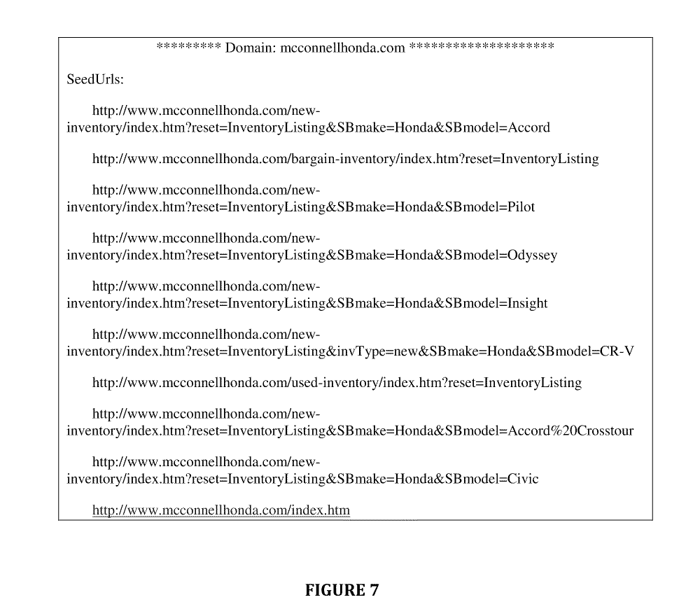

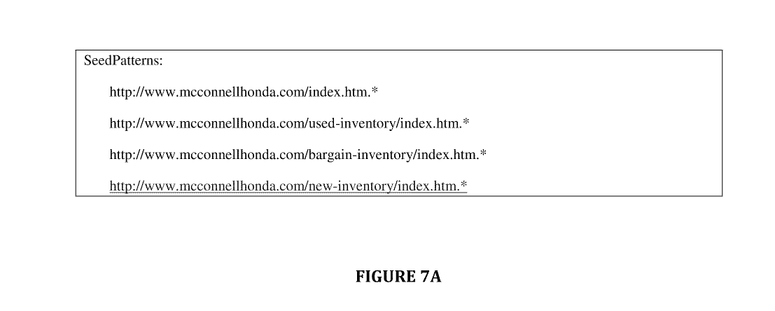

A histogram of the Referrer URL's is then constructed and the top Referrer URL's are extracted. These URLs are then used as seed URL's for the list crawl stage. FIG. 7 illustrates the seed URLs from the full discovery crawl provided in part in FIG. 6.

Stage 3: Listings Crawl

The listings crawl is designed to search the seed URLs and parse vehicle listings so that a normalized digital listing can eventually be constructed, searched on, and displayed.

The listings crawl is primed with the seed URL paths obtained from the discovery crawl stage described above. The listings crawl is constrained to remain within the URL path patterns provided by the discovery crawl. FIG. 7A provides exemplary URL path patterns, based on the URL seeds illustrated in FIG. 7. Results from the crawl are fed into a data repository for further parsing, normalization and analysis.

In an exemplary embodiment, the listings crawl returns an error if no vehicle listings are found at a URL that matches the URL path patterns for that domain. This error is logged and subsequently fed back into the discovery crawl to identity where the listings may have been relocated. For example the web site may have been redesigned and the inventory moved to a different path, the dealer may have changed its name, or may have simply gone out of business.

Universal Digital Vehicle Sticker

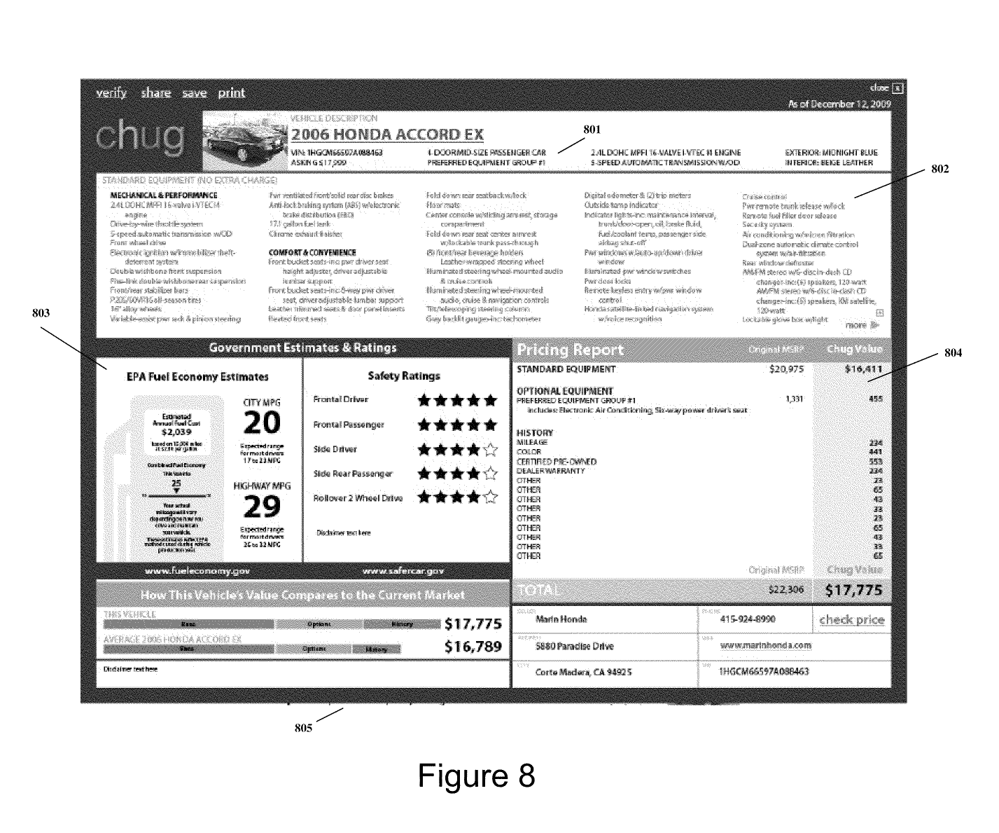

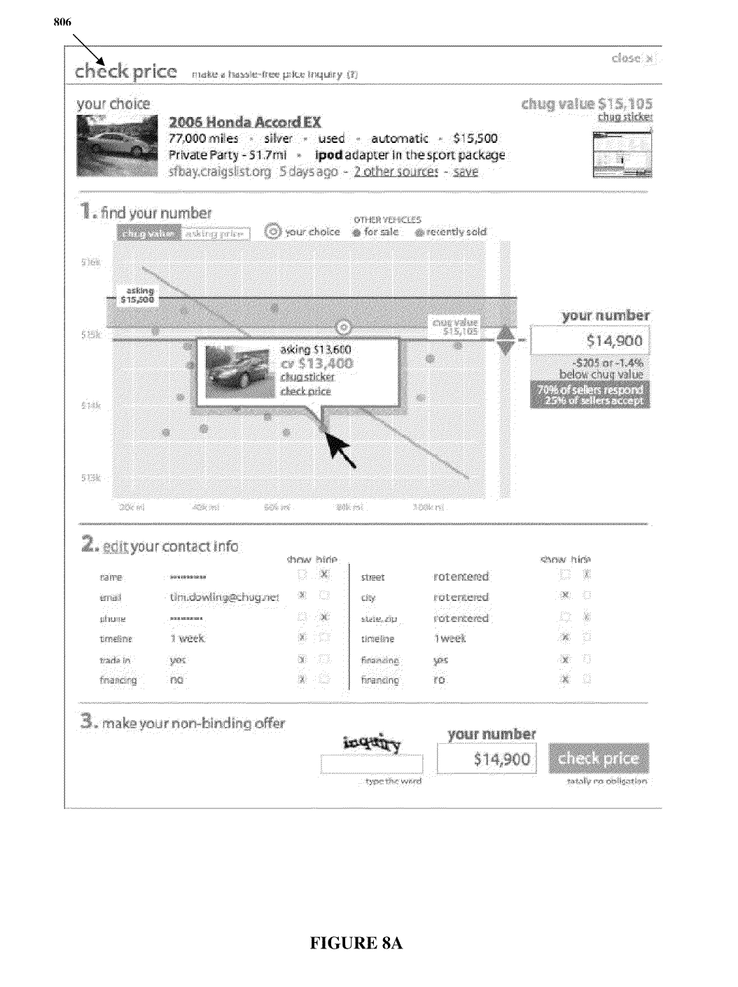

A Universal Digital Vehicle Sticker 800 in accordance with the present invention, as illustrated in FIG. 8, will now be described. For used vehicles, an exemplary Universal Digital Vehicle Sticker 800 mimics a Monroney sticker, but will also include information on previous vehicles owners, accident history, service history, warranty information, and recall information, for example. In another embodiment, the Universal Digital Vehicle Sticker will optionally include information relating to owner satisfaction and lifetime cost of ownership, such as servicing costs and resale value, for both new and used vehicles.

In an exemplary embodiment, the Universal Digital Vehicle Sticker is created by first identifying a vehicle in the vehicle database. The Universal Digital Vehicle Sticker is cataloged by Vehicle Identification Number and includes a digital record with data such as the original MSRP, original and optional equipment, safety ratings, mileage charts and pricing information, for example. The digital record is stored in a database as a “data blob” and a unique URL is created for the sticker. This unique URL can then be propagated to listing sites such as the listing dealer or other vehicle search webpages. When a prospective vehicle purchaser clicks on a link to the URL in a listing or in a set of search results in a vehicle search webpage, the data blob is retrieved and the sticker displayed.

In one embodiment, the Universal Digital Vehicle Sticker 800 is generated when requested by the purchaser, thus ensuring that the most up-to-date data is displayed. In another embodiment, the Universal Digital Vehicle Sticker 800 may be pre-computed for the most commonly displayed vehicles.

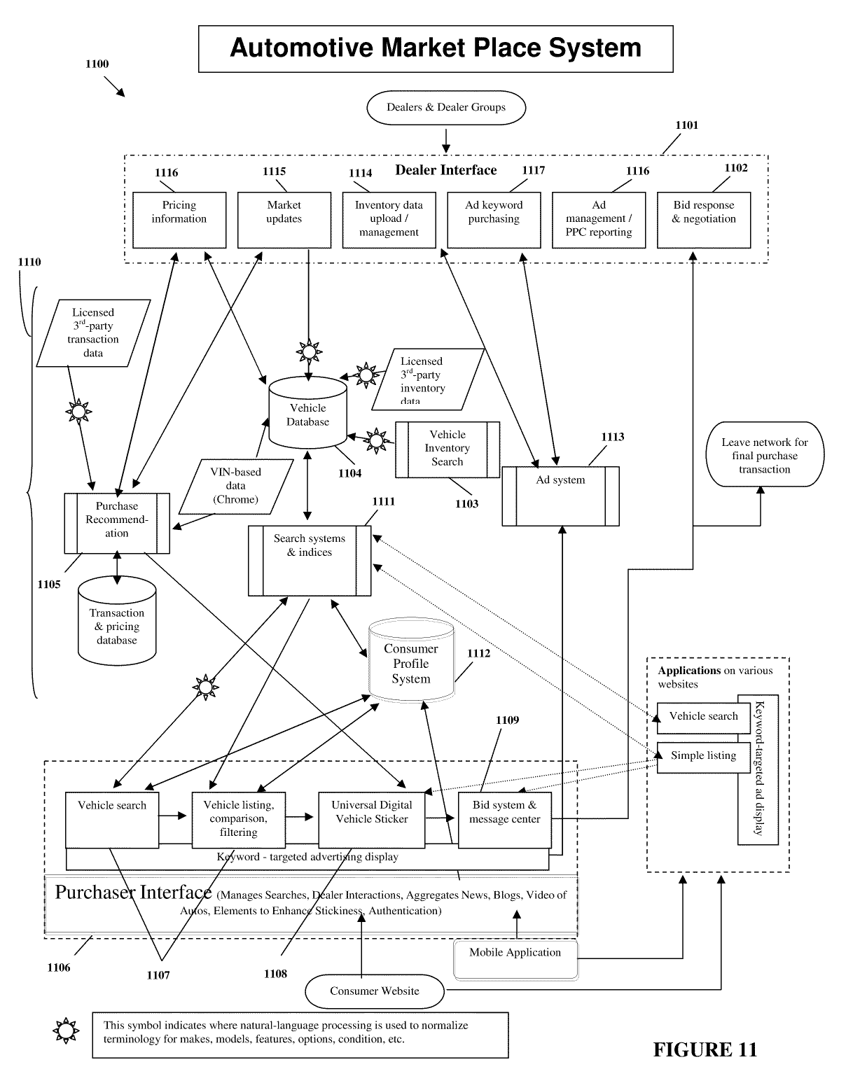

In some embodiments, the data displayed within the sticker is derived from a number of sources including the Vehicle Database via the Automotive Market Place System (“AMPS,” see FIG. 11) API (for the actual description of the vehicle and for comparable vehicles) and the purchase recommendation system (for pricing and market pricing intelligence), for example. Advertising may optionally be displayed on the sticker, leveraging information from a consumer profile system (see FIG. 11) and using an ad system (see FIG. 11) to serve the advertisements. Safety ratings and fuel consumption information may also be displayed using sources such as the National Highway Traffic Safety Administration car safety database and the Environmental Protection Agency fuel economy database. In one embodiment, the universal digital display sticker displays an actual image of the vehicle derived from the original listing or a stock image of the car make and model if an original image does not exist or is deemed to be of insufficient quality.

The Universal Digital Vehicle Sticker 800 may optionally include components that allow the consumer to interact with the dealer via the bid system & message center (see FIG. 11). For example, it may be possible for the consumer to issue an electronically routed query to the dealer to seek clarification on such things as options levels, condition of the bodywork, duration of remaining warranty etc.

The vehicle description section 801 provides a high level description of the subject vehicle and includes a thumbnail of the actual vehicle or optionally a stock image of the vehicle. The equipment section 802 describes the actual equipment present on the vehicle, separated into logical groupings, such as, for example, mechanical equipment (engine, transmission, suspension, etc), trim levels (body color, sports styling, leather seats, etc), and comfort and convenience (climate control, in car entertainment systems, cruise control, etc). In one embodiment, every parameter of the subject vehicle in the vehicle database is displayed. In others, the equipment section 802 uses an abridged format that describes core equipment (such as mechanical equipment and major trim level, for example) and presents only the major optional equipment known to be highly desirable or of high value (such as premium packages and performance/sport equipment, for example).

In one embodiment, the government estimates & ratings section 803 is obtained from relevant government data sources and mimics the data presented in a new car Monroney sticker.

In one embodiment, the pricing report section 804 is a tabulated representation of the items that typically exert major influence on the price of a used car, such as, for example, the vehicle's age, mileage, accident/owner history, remaining warranty, and options.

The current market data section 805 may represent market trend data as it relates to the vehicle in question. This data may be represented graphically (such as a scatter graph, or line chart, for example) or in tabular format and may contain such data as average asking price, selling price, mileage, and options level for this type of vehicle. Additionally, it may represent marketplace information such as the number of similar vehicles available within the marketplace, the average time similar vehicles remain on the market, and the number of purchasers searching for this type of vehicle.

FIG. 8A illustrates an exemplary bid system & message system 806, which may allow a consumer to interact with the dealer in order to establish key facts about the car or alternatively to enter into a price negotiation process.

The display format of the sticker may be standardized and controlled via Cascading Style Sheets (“CSS”), such as HTML or XML. In this manner, both the Universal Sticker and the underlying data blob are portable.

The sticker is designed to be printable, allowing a vehicle seller to print the sticker and physically display it on the vehicle for sale. This display continuity across digital and physical mediums further enhances the vehicle purchaser's experience. The sticker may further be used by the purchaser and dealer as the printed document of record for a sale since it can record all pertinent facts about the vehicle in a simple, standard format.

Purchaser Interface

A vehicle purchaser interface in accordance with an exemplary embodiment the present invention will now be described. The purchaser accesses the interface through an Internet page where she may enter the vehicle parameters to be searched. If the search terms do not sufficiently describe a vehicle, the purchaser is prompted for additional information, such as, manufacturer, model, year, and geographic area. An exemplary search assistance method is described in more detail below. The system then presents the best match from all available vehicles in the vehicle database, which may be determined by use of any of the purchase recommendation systems described above with respect to FIGS. 1-5.

In accordance with an embodiment of the invention, the purchaser can further refine their search and/or change the priority assigned to different parameters. The system will then research and re-sort available vehicles matching the purchaser's criteria to present the recommended purchases for the purchaser to compare. In accordance with an exemplary embodiment of the present invention, a user will be allowed to save their search terms, and the system will alert the consumer when matches are found based on their search criteria via, for example, an email, mobile phone text alert, or listing within the purchaser interface. Detailed information on a specific vehicle may be presented using the Universal Digital Vehicle Sticker described above.

Once a specific vehicle is identified, the purchaser can send an anonymous bid to the listing dealer. The purchaser interface may aid the user in choosing a bid price by providing advice about the current local market value of the specific vehicle and/or statistics about how likely a particular offer will be accepted, either in general or for a particular dealer. The purchaser can send anonymous bids to multiple dealers, and negotiate anonymously until she is ready to finalize the purchase.

In one embodiment, the present invention can further qualify both the purchaser and the seller thereby generating a higher quality search for the purchaser and a higher quality lead for the dealer. A purchaser may be qualified, for example, by selecting one of the vehicles presented to her by the present invention or by information she provided through the purchaser interface. The dealer is qualified by having possession of the vehicle which matches the purchaser's request. The purchaser and dealer can then negotiate directly on an actual purchase price, outside of the automotive market place system. Alternatively, in one embodiment, the system of the present invention may facilitate the exchange of funds, information, signatures, etc., and delivery of the purchased vehicle.

In a further embodiment, advertisements may be displayed on the purchaser interface and targeted based on the user's search terms, location, and vehicle models/features of interest. The automotive market place system of the present invention will manage the advertising system, allowing dealers to upload their ads and bid on selected advertising keywords for ad targeting.

In an exemplary embodiment of the present invention, the purchaser interface will permit purchasers to associate individual salespersons, or multiple salespersons in an automobile dealership, to specific vehicles for sale and allow purchasers to provide reviews and comments to the individual sales representative privately or publicly.

In yet another exemplary embodiment of the present invention, the purchaser interface is operable to include an options and pricing analysis for creating and displaying a “supply graph.” The supply graph may, for example, show a specific vehicle's competition within a geographical area based on vehicle configuration and history and may also show the relative number of searchers in the specific vehicle's market.

Keyword Enabled Vehicle Search

A keyword enabled vehicle search system in accordance with an exemplary embodiment of the present invention will now be described. To execute a more efficient and effective Internet vehicle search, keywords are evaluated to infer the user's intent, specific parameters are suggested to enhance the search, and results are returned based on their relevancy.

In accordance with an exemplary embodiment of the present invention, as the user enters keywords into the vehicle search, additional parameters are suggested, such as vehicle manufacturer, model, year, price range, number of previous owners, and number of accidents, for example. When the user selects a suggested parameter, the search phrase in the search box is modified to include that parameter. The keyword enabled vehicle search system of the present invention then re-executes the search using both the user's terms and the appended terms from the selected additional parameters. In this way, the present invention allows for a broader range of search terms and a more efficient and effective search of those terms.

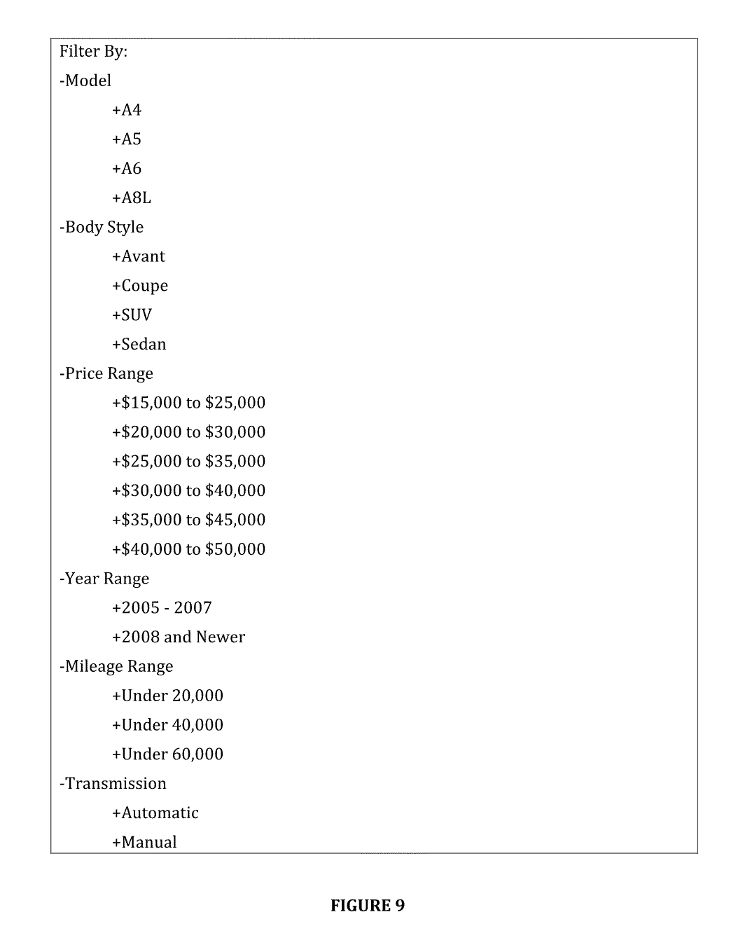

FIG. 9 illustrates an example of a parametric vehicle-listing search filtering system. In this example, the user can only filter the original search results using predetermined parametric filters, thereby constraining the search to the predetermined set of parametric filters and requiring significant upfront time investment.

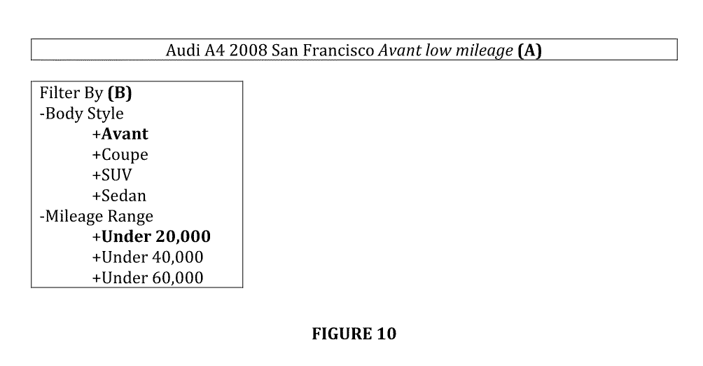

FIG. 10 illustrates a keyword enabled vehicle search system in accordance with an exemplary embodiment of the present invention. In this example, the user begins by entering a natural language search term in [A], in this case “Audi A4 2008 San Francisco.” Based on these keywords, the present invention visually alerts the user in [B] to additional parametric search filters relevant to the user's initial search terms. In this case, the user chose body style “Avant” and mileage “Under 20,000” from the parametric filters provided in [B]. The parametric filters are visibly added to the original search terms as natural language keywords (italicized terms in [A]) and the search is re-executed.

Because most users are very familiar with parametric search navigation, the visual cues of the present invention encourage users to switch from parametric search selection to keyword enabled vehicle searching. As illustrated in FIG. 10, once an initial search has been executed, a user is presented with a traditional parametric search navigation bar alongside the initial search results set, which retains the original search terms. When a user selects a parametric search term, the term is appended to the original search terms in natural language form and highlighted to show the user that the term has been added. In this way, the user may learn that future search refinements can be carried out using the search box instead of the parametric search navigation. Once the search term has been visibly added to the search box, the new search is executed and the refined results returned.

Another aspect of the present invention is to train the user to replace parametric terms, which may overly filter the result set, with more relevant, expansive keywords. As an illustration, mileage brackets are often presented as parametric filters, as illustrated in FIG. 9. However, it may be accepted that 12,000 miles per year is the average annual mileage of a personal use vehicle. Further, “low mileage” or “average mileage” are more natural and useful search phrases for a vehicle purchaser than a rigid mileage bracket of “xx,000-yyy,000” or “under zz,000 miles.” In FIG. 10, if a user selects in [B] a mileage bracket parametric filter of less than 12,000 miles per year (mileage divided by year of vehicle), the mileage bracket is replaced by the keywords “low mileage” in the keyword search box, thus training the user that the search box will accept natural language keywords in addition to rigid parametric filtering.

Dealer Interface

A dealer interface in accordance with an exemplary embodiment of the present invention will now be described. The dealer interface is a web based application for interacting with the automotive market place system, allowing the dealer to manage transmission of inventory data and providing the dealer with market research, pricing, and advertising tools.

For market research, the dealer interface may provide information about local and national vehicle transactions and pricing trends based on the vehicle database system described above, as well as data about vehicle inventory in the surrounding region. Some of the same data is useful for general pricing, but the pricing recommendation system described above can also be used by the dealership to price specific vehicles in their inventory. The Universal Digital Vehicle Sticker that is shown to purchasers is also available to dealers on the dealer interface.

For dealers participating in the advertising system, the interface also enables the purchasing of advertisements and tracking their performance. Advertisements are purchased by bidding on targeted keywords through a reverse-auction mechanism. Dealers can measure the responses and efficacy of specific advertising keywords and of the advertisements themselves.

Social Communication Platform

A social communications platform, in accordance with an exemplary embodiment of the present invention, allows potential customers to communicate anonymously with dealers to verify a vehicle's configuration or condition, for example, and to negotiate pricing, financing, or appointments to view and test drive the vehicle.

Automotive Market Place System

FIG. 11 illustrates an automotive market place system 1100 in accordance with an exemplary embodiment of the present invention. Automotive market place system 1100 incorporates many of the features described above with respect to FIGS. 1-10. In particular, the automotive market place system is designed to provide access to data and services to the major participants in the automotive marketplace namely purchasers (typically consumers) and sellers (typically auto dealers). As such, there are several major sub systems in the automotive market place system, namely a purchaser interface 1106, a dealer interface 1101, a business logic tier 1110, and a data acquisition sub-system (not shown, but comprises one or more Internet vehicle-inventory search systems 1103 for populating vehicle database 1104).

In one embodiment, online vehicle inventory data is acquired by the Internet vehicle-inventory search system 1103 and stored in the vehicle database 1104. This data is augmented with data from a variety of sources. Such data may include, for example, trim and option level data or accident and owner history data, as described in more detail above. Vehicle inventory data may also be acquired directly from dealers or their suppliers as a direct data feed from, for example, the dealer interface. The vehicle database 1104 may be made available to other internal sub systems in the Automotive Market Place System 1100 via an internal API published on search systems and indices 1111.

The search systems and indices 1111 are used to construct a search index that can be rapidly queried by the vehicle search component 1107 of the purchaser interface 1106. In this manner a consumer may submit a search request such as “2007 Honda Accord” via the vehicle search 1107 and receive a timely response to their query, as described in more detail above. Typically a consumer will then use the vehicle listing, comparison and filtering to further refine the results. When the consumer identifies a particular vehicle of interest, they may further investigate that vehicle's parameters and, optionally, may elect to display the universal digital vehicle sticker 1108. In one embodiment, the purchaser interface 1106 will allow the purchaser to display several vehicles at once. The universal digital vehicle sticker 1108 and purchase recommendation 1105 may be utilized in the comparison. In yet another embodiment, the purchaser may choose to interact directly with a dealer using, for example, the social communications platform 1109. Information displayed in the vehicle listing, comparison, filtering, and the universal digital vehicle sticker is derived variously from the purchase recommendation system 1105 and the search systems and indices 1111.

In one embodiment, the purchaser interface 1106 may be accessed via a web browser. In another embodiment, features of the purchaser interface 1106, such as, for example, vehicle searching and listing, may be offered on other websites or mobile applications. In yet another embodiment, the data in the automotive market place system is made available to partners via a published secure API for incorporation into their systems or websites.

In a further embodiment, purchaser interactions with the purchaser interface 1106 are recorded in the consumer profile system 1112. These interactions may be used to enhance the search results presented to a purchaser by, for example, providing search suggestions based on the purchaser's previous searches. Additionally, the consumer profile system 1112 may be used to provide market intelligence to the dealer via the dealer interface 1101, such as information on the makes and models of vehicles that the consumer has previously searched. In yet another embodiment, the consumer profile is used in the ad system 1113 to display targeted advertisements to the purchaser, which may be based on the consumer's prior searches and/or activity on the purchaser interface 1106.

In one embodiment, the dealer interface 1101 is accessed via a web browser. In another embodiment, some or all of its features may be made available via a partner system such as a Dealer Management System (“DMS,” not shown). The DMS incorporates an API based embodiment of the dealer interface 1101. The dealer interface 1101 may allow dealers to conduct market intelligence and analysis such as viewing the amount of inventory in their market 1115 and related pricing information 1116. Optionally, the dealer interface may provide data on consumer behaviors, relating to the dealer's inventory, via data in the consumer profile system 1112. The dealer interface may also allow direct uploading of inventory data 1114 into the vehicle database 1104. It may allow dealers to purchase advertising 1117 that will be displayed in the purchaser interface 1106 and, optionally, may allow dealers target advertising based on specific consumer behaviors or keyword searches. In such cases, it may provide reporting capabilities to help the dealer understand the performance 1118 of their advertising campaign. The dealer interface may also enable the dealer to interact with the purchaser via the bid response & negotiation 1102.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can, be applied, alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein as would be known to those of ordinary skill in the art. Additionally, for purpose of discussion, the various modules are described as discrete modules; however, as would be apparent to one of ordinary skill in the art, two or more modules may be combined to form a single module that performs the associated functions according to one or more embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system.

It will be appreciated that, for clarity purposes, the above description has described embodiments of the invention with reference to different functional units and/or modules. However, it will be apparent that any suitable distribution of functionality between different functional units, modules or domains may be used without detracting from the invention. For example, functionality illustrated to be performed by separate modules, processors or controllers may be performed by the same module, processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

What is claimed is:

1. A method for providing a purchase recommendation for a subject vehicle to a purchaser, the method comprising:
providing a first database of available vehicles;
creating a second database of similar vehicles by identifying vehicles in the first database that are similar to the subject vehicle;
assigning each of a plurality of vehicles in the second database to one of a plurality of comparable vehicle bands;
assigning an average offer price to each of the plurality of comparable vehicle bands;
assigning the subject vehicle to one of the plurality of comparable vehicle bands; and
providing the purchase recommendation for the subject vehicle by comparing the offer price of the subject vehicle with the average offer price of the subject vehicle's comparable band.

2. The method of claim 1, wherein providing the purchase recommendation further comprises:
providing a good price recommendation if the offer price of the subject vehicle is within 95-100% of the average offer price of the subject vehicle's comparable band; and
providing a great price recommendation if the offer price of the subject vehicle is less than or equal to 95% of the average offer price of the subject vehicle's comparable band.

3. The method of claim 1, wherein the first database of vehicles further comprises:
configuration parameters for the available vehicles comprising make, model, year, exterior color, interior color, standard equipment, optional equipment, and original MSRP; and
history parameters for each vehicle comprising number of miles, number of accidents, and condition of each vehicle.

4. The method of claim 3, wherein the plurality of vehicle bands comprises first, second, and third comparable vehicle bands and wherein the first comparable band of vehicles comprises vehicles in the second database which have less than a first number of miles driven, the second comparable band of vehicles comprises vehicles in the second database which have between the first number and a second number of miles driven, and the third comparable band of vehicles comprises vehicles in the second database which have more than the second number of miles driven.

5. The method of claim 3, wherein the plurality of vehicle bands comprises first and second comparable vehicle bands and wherein the first comparable band of vehicles comprises vehicles in the second database which have no accidents and the second comparable band of vehicles comprises vehicles in the second database which one accident.

6. The method of claim 3, wherein creating the second database of similar vehicles further comprises identifying vehicles which are the same manufacturer, model, and year as the subject vehicle.

7. The method of claim 1, further comprising providing a communications platform operable to facilitate purchaser-dealer communication.

8. The method of claim 7, further comprising providing a purchaser interface operable to facilitate entry of search parameters and display a universal digital vehicle sticker.

9. The method of claim 7, further comprising providing a dealer interface operable to provide an interface for purchasing and tracking advertisements, facilitate dealer-entry of pricing and inventory updates, display a universal digital vehicle sticker, and provide a dealer communications interface associated with the communications platform.

10. A method for ranking vehicles for sale, the method comprising:
providing a first database of available vehicles;
creating a second database of similar vehicles by identifying vehicles in the first database that are similar to a subject vehicle;
creating a third database of ranked vehicles by determining a vehicle rank score of each of the vehicles in the second database, wherein determining a vehicle rank score of a vehicle comprises:
calculating a base score of the vehicle;
calculating a multiplier of the vehicle; and
determining the vehicle rank score of the vehicle by multiplying the base rank by the multiplier.

11. The method of claim 10, wherein the first database of vehicles further comprises:
configuration parameters for the available vehicles comprising make, model, year, exterior color, interior color, standard equipment, optional equipment, and original MSRP; and
history parameters for each vehicle comprising number of miles, number of accidents, and condition of each vehicle.

12. The method of claim 11, wherein calculating a base score of a vehicle comprises calculating a base score for the vehicle based on a plurality of the vehicle's configuration parameters and history parameters.

13. The method of claim 12, wherein calculating a base score of a vehicle further comprises summing each of the base scores for the plurality of the vehicle's configuration parameters and history parameter.

14. The method of claim 12, wherein calculating the multiplier of the vehicle comprises:
assigning each of the vehicles in the second database to one of a first, second, third, and fourth quarter percentile of vehicles, wherein the first quarter percentile of vehicles comprises vehicles in the 75-100% percentile of vehicle base score for vehicles in the second database, the second quarter percentile of vehicles comprises vehicles in the 50-75% percentile of vehicle base score for vehicles in the second database, the third quarter percentile of vehicles comprises vehicles in the 25-75% percentile of vehicle base score for vehicles in the second database, and the fourth quarter percentile of vehicles comprises vehicles in the 0-25% percentile of vehicle base score for vehicles in the second database;
calculating the average price of the vehicle's base score quarter percentile; and
calculating the vehicle's multiplier by dividing the average price of the vehicle's quarter percentile by an asking price of the vehicle.

15. The method of claim 10, wherein creating the second database of similar vehicles further comprises identifying vehicles which are the same manufacturer, model, and year as the subject vehicle.

16. The method of claim 10, further comprising displaying the top-ranked vehicles to a user.

17. A computer readable medium containing executable instructions that when executed perform a method of ranking vehicles for sale, the method comprising:
providing a first database of available vehicles;
creating a second database of similar vehicles by identifying vehicles in the first database that are similar to a subject vehicle;
creating a third database of ranked vehicles by determining a vehicle rank score of each of the vehicles in the second database, wherein determining a vehicle rank score of a vehicle comprises:
calculating a base score of the vehicle;
calculating a multiplier of the vehicle; and
determining the vehicle rank score of the vehicle by multiplying the base rank by the multiplier.

18. The computer-readable medium of claim 17, wherein the first database of vehicles further comprises:
configuration parameters for the available vehicles comprising make, model, year, exterior color, interior color, standard equipment, optional equipment, and original MSRP; and
history parameters for each vehicle comprising number of miles, number of accidents, and condition of each vehicle.

19. The computer-readable medium of claim 18, wherein calculating a base score of a vehicle comprises calculating a base score for the vehicle based on a plurality of the vehicle's configuration parameters and history parameters.

20. The computer-readable medium of claim 17, further comprising displaying the top-ranked vehicles to a user.
